(19) United States
(12) Patent Application Publication
(10) Pub. No.: US 2016/0071145 A1
(43) Pub. Date: Mar. 10, 2016

(54) SYSTEM AND METHOD FOR INTEGRAL ASSESSMENT OF THE EFFECTIVENESS OF PROMOTIONAL COMMUNICATIONS

(71) Applicant: INTELIMIDIA SOLUÇÕES EM INTELIGÊNCIA MERCADOLÓGICA LTDA., São Paulo (BR)

(72) Inventor: Rodrigo Paraná SANCHES, São Paulo, SP (BR)

(21) Appl. No.: 14/653,958

(22) PCT Filed: Dec. 19, 2013
(86) PCT No.: PCT/BR2013/000582

§ 371 Date: Oct. 26, 2015

(30) Foreign Application Priority Data
Dec. 21, 2012 (BR) BR 10 20120329093

(51) Int. Cl. G06Q 30/02; H04W 4/14

(52) U.S. Cl. CPC G06Q 30/0246; H04W 4/14; G06Q 30/0267

(57) ABSTRACT

A system for a precise and complete assessment of the effectiveness of promotional communications, integrating, in a single platform, the measurement of the multiple ways a consumer can engage to an ad published in an offline medium. The system includes and integrates one or more entities A of advertisers (1), one or more entities V for placement (2) having servers connected to an advertising database (5), an entity S providing a service of responses monitoring (3) having one or more servers (7) connected to an advertising database (6) with active tags, a plurality of entities C of consumers (4), a telecommunication system T (8), at least a device DR for redirectioning (9) of calls, entities L of retail stores (11), generation of electronic coupons (12) through mobile phone SMS or social media messages, and interfaces (10) for monitoring responses in real time. A method is also described that includes a campaign set-up step, a tracking step and an optimization step.

### FIELD OF THE INVENTION

The present invention concerns the field of Information Technology applied to promotional communications. More specifically, it refers to an integrated system and a method for increasing the efficiency of promotional communications in offline media, as well as online media, with real time analysis of consumer responses.

The invention further provides means for integration, in a single platform, of all possible forms of consumer response to promotional communications, integration which ensures robustness and reliability of measurement, and facilitates the use of the system by its users.

The invention also provides a more accurate approach for calculating the return of investment in advertising, as well as provides means to significantly increase the efficiency of advertising campaigns, which can be used by advertisers, providing a better result per investment unit, as well as by publishers, allowing increased advertising revenue.

For a better understanding of the invention, some terms, acronyms and expressions used in this report are presented below:

Analytics—Combined application of computer technology for precise generation, collection and measurement of different types of data or information, in order to solve problems in business activities.

AdTracker—Tool for monitoring advertising campaigns, providing information related to the effectiveness of advertisements and the return of advertising investment.

AEM (Advertising Efficiency Management)—Acronym used for efficiency management systems in advertising.

Institutional Communication—Communication having as its main goal the increasing of brand value and also its “awareness” (consumer familiarity related to the brand). It is typically a long term endeavor, aiming at the creation of a positive image concerning an organization, company, person, or product.

Promotional Communication—Unlike institutional communication, which focuses on the creation of brand value in the medium and long terms, promotional communication aims at selling of one or more specific products or services in the short term. Also known as “sales communication”, promotional communication consists of actions that typically contains price, or some “call to action” by the consumer, and they invariably provide information about channels for action (company phone, company website and/or physical addresses of their stores.)

CRM (Customer Relationship Management)—Software solutions for managing a company's relationship with its customers. It often includes tools for support and order generation, customer registration, monitoring of account services, as well as other functionalities.

ERP (Enterprise Resource Planning)—Software platforms that integrates most data and processes of an organization into a single system. This integration can happen from a functional viewpoint (financial, accounting, human resources, manufacturing, marketing, sales, purchasing systems and so on) and from a systems viewpoint (processing of transactions, management information, decision support, and so on). In general, ERPs are software platforms developed for integration of the various departments of a company, enabling automation and storage of most business information.

Offline Media—Also called “traditional” media, they are the group of media formed by newspapers, magazines, TV, radio, cinema, billboards, tabloids, newsletters, directories, and also as separate items such as brochures, direct mail, folders, flyers, pamphlets, posters, booklets, and so on.

Online Media—In the context of advertising, online media is virtually a synonym for media on Internet, i.e., advertising actions through banners, pop-ups, “display” or “text” advertisements, conveyed in websites, portals, social media or search engines, such as Google.

POS—Stands for “Point of Sale”, a hardware or software solution that allows retailers to process their transactions.

Respondent—In the context of the invention, it is the consumer who responds to an ad after being stimulated by it.

SMS (Short Message Service)—Text message service in mobile communication systems, that use standard communication protocols allowing the interchange of short text messages between mobile phones.

Tag—A term commonly used in online advertising (Internet), wherein “tag” means a code line for generation of “analytics” to the advertising piece or web page linked to it. For example, a tag placed on a banner allows knowing how many times the banner has been placed and also how many times it has been “clicked”.

Active Tag—In the context of the present invention, “active tags” are individual phone numbers, or individual URLs, or individual SMS keywords, or individual e-mail addresses tied to an advertisement, which receive a response from a consumer and redirect such response to their original destination, generating analytics during the process. It allows an accurate count of the number of responses, while the communication between respondent and advertiser is maintained without change.

Online Media Tracking—Efficiency monitoring of the advertising taking place on the Internet, through analytics management software.

URL (Uniform Resource Locator)—It is the address of a resource (file, webpage and so on) available in a network such as the Internet or a corporate network, i.e., an intranet. In short, it is the address of a website, for example “www.mydomain.com”.

### BACKGROUND OF THE INVENTION

Advertising investment is a major component of the cost of many companies. However, there has not been developed as of yet a system and method capable of accurately evaluating the effectiveness of advertising in offline media (TV, radio, newspapers, magazines, and so on), as well as the return of the investment made in such media.

Hundreds of billions of dollars are invested yearly in offline advertising campaigns across global markets, with specific advertisers allocating more than hundreds millions of dollars a year in markets such as the U.S. alone.

However, there is no such system that would allow a precise and complete evaluation of efficiency of offline media campaigns, which would integrate the measurement of all forms in which an advertisement can generate a result, making the data available in a single platform, and in real time.

In different parts of the world there is an usual practice of ads which main goal is to attract customers to stores, to offer promotional coupons (usually paper based) as a way of attracting customers and also somewhat measure overall ad efficiency, at least partially, through the tracking of coupons redeemed.

This practice, however, does not use SMS or social media as a way for the customer to request a coupon, does not generate analytics related to the requisition and redemption of a coupon, neither is integrated with the retail POS system, operating as a single platform.

Though unusual, there is also the practice of using individual phone numbers for media tracking.

However, the use of analytics as means of measurement of the effectiveness of the actions performed in online media is an usual practice, quite widespread nowadays.

Patent US 2012078694 (Tavares et al.) entitled “ANALYTICS SYSTEMS AND METHODS FOR DISCOUNT INSTRUMENTS” describes a system and method that measures the efficacy of a promotion through use of data collected in the POS, such as store and promotion identifications. The promotion may comprise of a benefit to the consumer during the transaction carried out at the POS, such as a discount, a coupon, and so on. Such promotions, which include an identification code, may be available both through online and offline media. However, the method does not evaluate the effectiveness of an advertisement, i.e., it does not correlate the process steps, which begins with the publication step, and ends with the purchase interaction between client and advertiser (or retailer).

However this system offers no solutions of analytics for advertising campaigns in offline media, integrating all possible forms of consumer response, let alone allowing measurements made at the individual level of each publisher, measuring all types of responses (calls, website visits, or actual store visits), all in real time.

US 2008091516 (Giunta) “RESPONSE MONITORING SYSTEM FOR AN ADVERTISING CAMPAIGN” discloses a system that includes an advertiser of a sub-system that is associated with a network analytics through the server of the advertising campaign of the customer. The advertiser uses the network analytics to capture responses for each ad. The responses originated from each publisher are stored in the historical database of each server of the campaign. These responses are specific for each advertisement that has been placed on any offline media—radio, television, newspaper or magazine.

However, this system does not offer solutions and decisions for advertising campaigns in offline media integrating all possible forms of consumer response, let alone allowing measurements regarding each ad in each publisher, measuring all possible types of response—calls, website visits, or actual store visits—all in real time.

US 2008255944 (Shah et al.) “CAMPAIGN MANAGEMENT PLATFORM FOR NETWORK-BASED ONLINE ADVERTISING AND DIRECTED MEDIA TRANSMISSION SYSTEM” discloses a system and method for managing multimedia advertising campaigns through online media and offline sources.

In this system, a network identifier is assigned to each client device, which is used to access an advertising network. The identifier comprises an alphanumeric tag associated with the network traffic, transmitted via network routing devices.

The identifier indexes demographic information from relevant users and from client device, facilitating the distribution of directed media in the advertising network, with the identifier embedded in requests sent by the client's campaign to a target server in a network.

A campaign management platform processes certain user metrics provided by the tag processing service and completes its information with certain extrinsic data. Analysis processes determine behavioral or contextual goals as well as user responses to messages.

However, just like the above mentioned patent specifications, the system does not provide solutions and decisions for advertising campaigns in offline media, integrating all possible forms of consumer response, much less allowing measurements made in real time on the level of every ad in each publisher, detailing all possible ways for engagement.

US 2011054860 (Guild et al.) “ADAPTIVE ANALYTICS MULTIDIMENSIONAL PROCESSING SYSTEM” discloses a multidimensional data processing system that stores meta-data identifying a plurality of variables, which describes attributes thereof, and a plurality of levels in each dimension.

The meta-data also identify a hierarchy of dimensions and levels for each variable. The multidimensional data processing system is designed to use the meta-data to perform multidimensional mode queries in order to extract data from one or more of the database variables.

The system also includes a module of determination of variables, which determines at least one variable among the plurality of variables to be used to generate the model, and a generator model that receives these data from a multidimensional data processing system, generating a model, which uses such data.

This system, however, does not offer solutions and decisions that may serve as guidelines for the advertising campaigns in offline media, integrating all possible forms of consumer response, let alone allowing measurements made at the level of each ad in each publisher, with measurements for all possible types of customer response, all in real time.

US 2010042403 (Chandrasekar, Bai et al.) “CONTEXT BASED ONLINE ADVERTISING” discloses a system and software that directs online advertisements to specific users, from the monitoring of that user's interactions with a mobile telecommunications terminal, i.e., a cellphone. From the analysis of the most frequent terms in the speech of the user, the frequency of his access to certain sites, the system determines the user's topics of interest and sends specific advertising material for that user, regardless of any action by the latter.

The method employs sentiment analytics data, which, in addition to determining consumer preferences, includes other types of data that can be captured in the digital universe, such as the cellphone type, the place where the customer is (through the cellphone GPS), which sites are browsed, how often and for how long, what type of advertising has resulted in some kind of interaction, and so on. Such procedure is commonplace in online media, since the analytics is an inherent part of the digital world and therefore need not be generated per se, but only captured and analyzed.

However, the system does not address the problem of enabling the generation of data (analytics) in offline advertising. This is due to the fact that, unlike digital media, offline media do not generate data automatically.

Therefore, there is no known system that offers solutions and decisions of analytics for advertising campaigns in traditional offline media, integrating all possible forms of consumer response.

### OBJECTS OF THE INVENTION

In view of the above, it is the main object of the present invention to provide an integrated information system for the assessment and monitoring of promotional communications, and a method that provides increased efficiency of advertising in offline media, with real time analysis of consumer responses.

It is also an object of the invention to provide means to enable all typical ways of consumers to engage from an offline ad—to call, visit a webpage or go to an actual store—to be measured with precision, with the highest granularity, in real time, and in a single unified platform.

It is also an object of the invention to provide a method ensuring the robustness and reliability of the measurements, as well as facilitating the use of the system by the various users.

It is yet another object of the invention to provide a system and method that provide efficient means for calculating the return of advertising investment, as well as means to predict and increase the efficiency of advertising campaigns.

A further object of the invention is to create a new response channel in ads, besides those already existing (telephone, webpage, physical addresses), through the use of SMS in a way that allows sending a coupon to the consumer, directly from the ad itself. This coupon can be automatically redeemed in the advertiser's stores, even when the advertiser is not the same company as the one who holds the point of sale where the coupon is being redeemed. The advertiser is a manufacturer of a consumer good, and the redeemer is a retailer.

Finally, it is a further object of the invention to provide a system to be used both by advertisers, providing increased profit per unit of investment, and by the publishers, in order to provide increased advertising revenues.

### SUMMARY OF THE INVENTION

The stated above objects are achieved by the invention through the provision of an information system and method, which operate together in order to manage in real time and maximize the results of promotional campaigns in offline or online media, both to advertisers and publishers alike.

Initially, it is important to distinguish between institutional communication, which is focused on generation of value for the brand, and promotional communication, which is focused on generating short-term sales.

Typically, promotional communication ads are those that invite consumers to act, being intended to cause the consumer to engage the advertisement through a telephone call, website visit or physical store visit, in order for him to make a purchase of the product or service offered.

According to one aspect of the present invention, the system of the invention is characterized by measuring in real time the number of consumers' responses who respond to each offline media ad, regardless of the response channel.

There are basically four ways, or response channels, that customers can use to engage in an offline media ad (such ones published on TV, radio, billboard, newspaper, magazine, etc.).

The four response channels are:
(a) Phone: calling the advertised phone number;
(b) Web: entering the website URL advertised on the ad;
(c) Coupon: requesting/detaching a coupon from an ad in order to redeem it later at a store;
(d) Store visit: personally visiting a business establishment, which may be the establishment of the advertiser itself or a retailer's establishment.

According to another feature of the invention, the system uses means (herein called active tags) which can correspond to (1) individual phone numbers, (2) individual URLs, or (3) individual keywords for digital coupons, to identify the specific number of responses generated by each ad, along with other analytics, in a totally transparent way to both customers and advertiser13 who receive calls or visits the same way as they always did—despite the generation of analytics that is now occurring.

According to another feature of the invention, said active tags are automatically generated on an integrated platform, allowing efficiency measurement for each ad of a campaign, in real time, 24×7, in any device (desktop, tablet or cellphone). Said integration brings together the management systems of at least one advertiser, at least one medium, and a service provider for the monitoring of the responses.

According to another feature of the invention, related to the identification of respondents who personally go to the retail stores, the system of the invention provides the sending of electronic coupons to a mobile phone (hereinafter called CupomMobile) and the integration of these electronic coupons with the POSs (points of sale) on a single platform. Preferably, the POSs have means to communicate with the system in order to allow real time tracking. In case of absence of such integration, the invention also comprises an independent system to validate the redeeming of coupons.

According to another feature of the invention, the system provides the advertiser with information concerning the number of issued coupons, how many were used (redeemed), and the associated analytics, such as, for example, where, when and in what type of purchase they were used, and from what kind of media and advertisements the process was originated.

According to another feature of the invention, the system provides the advertiser and the retailer with information allowing campaign management on a much wider scale, which structurally improves the “economics” of promotions (nowadays dependent on the management of parallel stocks of gifts, the presence of sales promoters in stores, and various further complicating issues).

According to another feature of the invention, the system allows the elimination of separate stocks of the promoted product, eliminating logistics nightmares for advertisers and retailers and significantly reducing costs.

According to another feature of the invention, the system is able to generate a significant increase in total sales, allowing the execution of a variety of sophisticated promotions (i.e: conditional redemption based on days of the week, timetables, markets, etc.; dynamic redemption periods, etc.) which, in addition to generating higher sales volume and address specific retail operating goals, enables a much more efficient use of advertising resources, by adding the “mass” feature of these media (print and broadcast) to deliver coupons in high volume.

According to yet another feature of the invention, the system comprises programming means in an integrated platform for media monitoring (tracking), integrating all the response channels in a single database.

The system operates with real analytics parameters, a feature that allows assessing the actual efficiency of an advertisement that is generating results through several response channels. Such an approach is completely different from research, which uses sampling and statistical extrapolation techniques, rather than counting the precise number of responses generated by an ad.

Furthermore, this feature enables further analysis to be performed because the analytics parameters are stored in a single multidimensional database (“hypercube”), enabling any kind of cross-analysis, which would be impossible if such data were not integrated into a single database.

Thus, the system of the invention addresses the maximization of the advertisement efficiency, being a true “Advertising Efficiency Management”(AEM) system and not just a “Customer Relationship Management”(CRM) system that manages the interaction with the customer (or potential customer) only after the time when the costumer has contacted the company.

Indeed, the system of the invention manages the previous step (before the CRM management), i.e., what happens between the publication of an advertisement and the contacting of the consumer with the advertiser, which can be an manufacturer, a retailer or a service provider, for instance.

The analytics generated by the system of the invention allows the following:
a) Performing the calculation of ROI (Return on Investment) related to advertising. That is, the advertisers may know precisely the cost of the response (“lead”) generated by each specific advertisement. In the case of CupomMobile, the advertiser can accurately calculate the overall process ROI, from the placement of the advertisement up to the consumer's transaction at the point of sale.
b) Optimizing the media. Initially, from the direct correlation of the advertisement cost with the number of responses generated, it is already clear what budget reallocation action between media or publishers will generate higher earnings (more responses) from the same investment. Not only the allocation among media and publishers can be optimized, but among many other variables as well, such as size, placement day (weekday, time of the month or season of the year), format, programming, content, etc. Additionally, sophisticated statistical predictive tools of the system allow the user to optimize future advertising efforts by allowing the best configuration possible for campaigns.
c) Optimizing conversion. As the system centralizes all phone calls, for example, it yields very important information for the advertisers that could not be produced by other means, such as the quantitative monitoring of phone calls. When, after seeing an ad, consumers try to call the advertiser but find busy lines or the calls are not answered, this information does not reach the advertiser in a centralized manner or in real time. In the method of the invention all calls are processed by the system, the system knows the precise percentage of missed calls, either due to no answer or unavailability of the line (busy or down). Furthermore, the system allows the qualitative monitoring of calls through its interface, enabling their recording and allowing them to be heard and evaluated at any time.

Finally, the system allows the automatic generation of a hugely valuable database of respondents, whereas in the absence of the proposed system such information would not be generated or would not be available for the system users. For example, the advertiser can find out the customer's name and address, the caller's phone number, the time of the call, the result of the call, duration of call, geographical location, and so on.

The advertiser can then create a database of respondents, return missed calls, perform marketing campaigns, understand from which geographical region the demand is coming from each particular ad, understand the average duration time of servicing the calls, and the distribution of calls during the day to achieve a better allocation of the attendants, and so on.

A special advantage of the invention is associated with the possibility of its use by the publishers. In other words, the system provides tools so that the publishers themselves not only can generate analytics, but also make them available to their clients, in other words, to advertisers.

The system and method of the invention provides the following new high-impact outcomes:
a) Provision of sophisticated tools for analytics to small advertisers, with all their associated benefits (ROI measurement, optimization, campaign CRM data, and so on).
b) Generation of a mass of data which would not be possible if the invention was used exclusively by advertisers (for example, concerning the average selling price of a real estate category in the district X of the town Y—which could be known, in real time, if the most relevant publishers who place real estate ads are participants of the system).

Enables offline media publishers, for the first time, to practice the pricing model so revolutionary and so successful that up to now has only been conducted in the digital environment: the model wherein the advertisement price is defined by its efficiency (as opposed to by its audience reached). On the internet, this is broadly know as CPC, or “cost-per-click” model, a model in which the advertiser pays not for having its ads shown, but only when its ads are clicked on. This model cannot nowadays be reproduced in the offline world to the extent that there are no efficiency analytics on which to base it.

With the invention, publishers are able to price their products in a way that greatly increases their revenues by increasing the outcome from each client (yield management) as well as dramatically increase their market share, since nowadays less than 1% of companies advertise, a condition due the advertising risks, which would disappear—or at least highly mitigated—with a price model based on engagement (“cost per response” model, analogous to the “cost per click” above).

The system and method of the invention may be embodied in different ways depending on their specific application.

In a preferred embodiment, to be detailed, the system and method of the invention provide means to be used by the publisher entities (V) and the advertising entities (A), for communications related to classified ads, which are also known as “line-advertisements”.

In this embodiment the system of the invention measures and processes analytics specifically related to classified advertisements, that is, which contain only text.

According to this embodiment, the consumers, when responding a classified advertisement, use the same central phone number common to all advertisements, and then type in the advertisement code number to have their call directed to the advertiser, as will be detailed.

In a second preferred embodiment of the invention the system is customized for advertisements that have images, also called “art-ads”. In this case the system provides advertisements templates, associated with a customization tool, thus allowing the creation of individual, customized, finished layouts, but in a rather prompt way. This functionality lies in tablets that interface with the ARM system of the invention, in order to allow the production of the finished artwork at the client's premises by the seller of the advertisements, at the time the sale is being made, and having already inserted in said advertisements all the tags for generation of advertisement analytics.

There is yet another preferred embodiment of the invention, which uses the concept of Ad Network, well known in the Internet world, but applied to offline media. In this embodiment, therefore, the invention can be applied to publishers such as newspapers, magazines, TV, radio, and so on.

AdNetworks are companies representing several websites commercially, allowing such websites not to have an exclusive, dedicated, expensive sales force as the only way to sell advertising. In this way, thousands of websites put their page-view inventories available to an integrating company, which sells them for a commission.

The fact that the invention can be used by publishers, which naturally concentrate a plurality of advertisers, allows the collection of general market information that formerly would not possible to be accurately performed or at a feasible cost. The information is, for example, sales prices of goods, increasing/decreasing of purchasing intention by consumers segment, which publishers work best for which audience, what products or approaches generate more consumer response, and so on.

The system of the invention also provides integration with management systems through “off the shelf” solutions, integration with leading CRM and ERP software in the market, extending the value of these solutions and enabling an understanding of analytics throughout the sales funnel and customer life cycle, from the placement of an ad all the way to client-service.

### BRIEF DESCRIPTION OF THE DRAWINGS

The invention will be better understood through the hereinafter specification which makes reference to the appended figures, wherein:

FIGS. 1-a, 1-b and 1-c show exemplary block diagrams of the system in its various embodiments, showing its major components:
Entity A—advertiser (1);
Entity V—publisher (2);
Database (BD) of advertisements of entity V (5);
Entity S—service provider of responses monitoring (3);
Server of entity S (7);
Advertising database of entity S (6);
Entity C—consumers (4);
Telecommunication system T (8), comprising landline and mobile telephony, e-mail and web;
Device (DR) for redirectioning (9);
Entity L—retail stores (11);
Electronic mobile coupon (12);
Set of interfaces (10) for responses monitoring in real time.

FIG. 2 shows a flow graph of the method of the invention, which comprises the main steps corresponding to the embodiments illustrated in FIGS. 1-a and 1-b.

FIG. 3 shows a diagram exemplifying the main consumer response channels associated with the system of the invention.

FIG. 4 is an example of interface (10) showing management information automatically updated with information associated with consumer responses to a promotional communication, in a preferred embodiment.

FIG. 5 shows a flow graph of the method of the invention, comprising the main steps corresponding to the embodiment illustrated in FIG. 1-c.

### DETAILED DESCRIPTION OF A PREFERRED EMBODIMENT

The complete method of the invention comprises a first step of campaign set-up, a tracking step and an optimization step.

The set-up step comprises the association of all data of a promotional campaign (advertiser's and campaign name, ads' identification names and numbers, start and end date, days for publication, media utilized, formats, and so on) with specific active tags.

In the tracking step all analytics are shown to the advertiser, that is, the most relevant information (correlations, analysis) are shown in the most intuitive and understandable possible way, thought a real time interface, available 24×7 in any device able to connect to the Internet.

In the optimization step statistical algorithms are applied to analyze variances and correlations between numerous variables managed by the advertiser (where and when to place the ads, how often, what size and format should be used, what sections, what product, what offer, what media, which investment, and so on), identifying the main variables that, when altered, will have the greater impact on results.

The invention can even suggest, automatically, though the use of sophisticated algorithms, the optimal media plan, as well as provide ideal budget sizes, and campaign periods.

Following are descriptions of the preferred embodiments of the invention:

According to FIG. 1-a, the system for monitoring responses to promotional communications comprises one or more entities A of advertisers (1), one or more publisher entities V (2) for placement, having servers connected to an advertising database (5), an entity S providing a service of responses monitoring (3), having one or more servers (7) connected to an advertising database (6) with active tags, a plurality of entities C of consumers (4), a telecommunication system T (8), including landline and mobile telephony and web, a device DR for redirecting (9) of calls, one or more entities L of retail stores (11), and a set of interfaces (10) for responses monitoring in real time.

FIG. 1-b shows a monitoring system wherein the tags are inserted in the advertisement by the advertiser (1). It differs from the previous one by the fact that it does not have the advertising database (5), which exists in the previous configuration.

FIG. 1-c illustrates a monitoring system that uses electronic coupons (12) issued by the entity S (3). In this case, the communications between consumers C (4) and the entity S providing a service of responses monitoring (3) are performed exclusively via mobile telephony system through SMS messages.

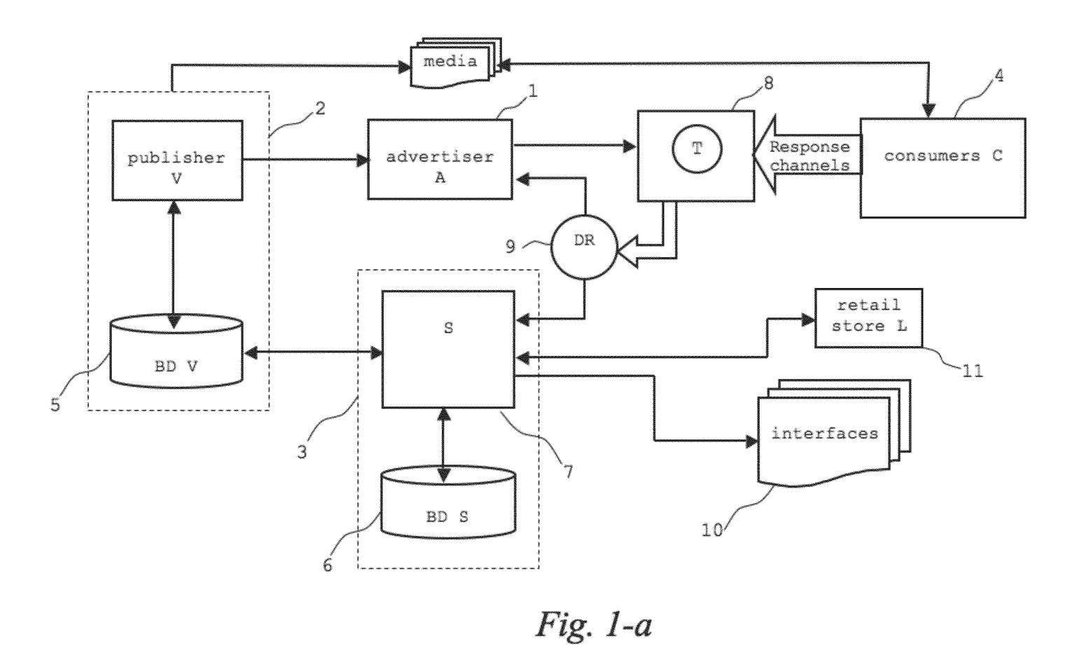

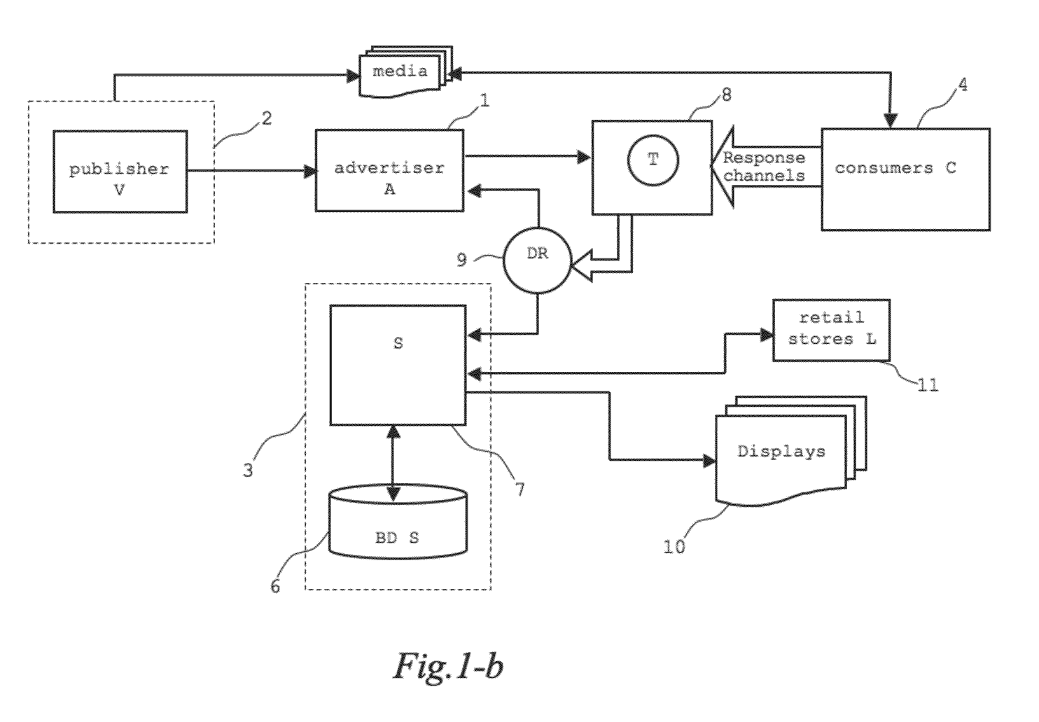

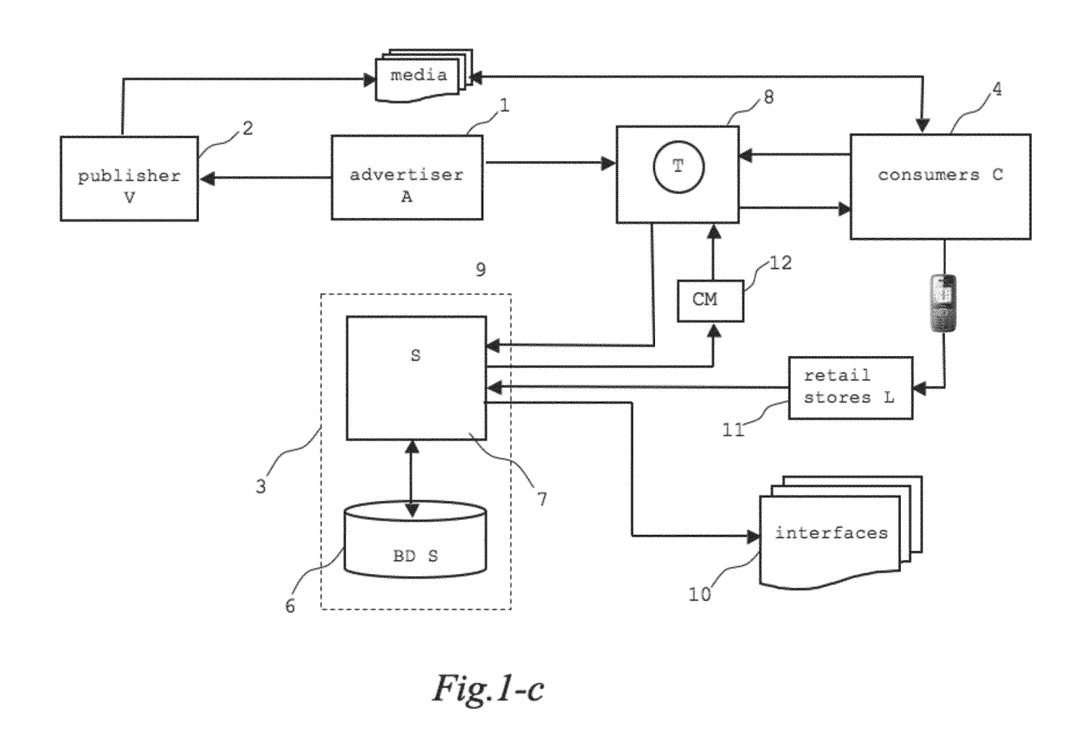

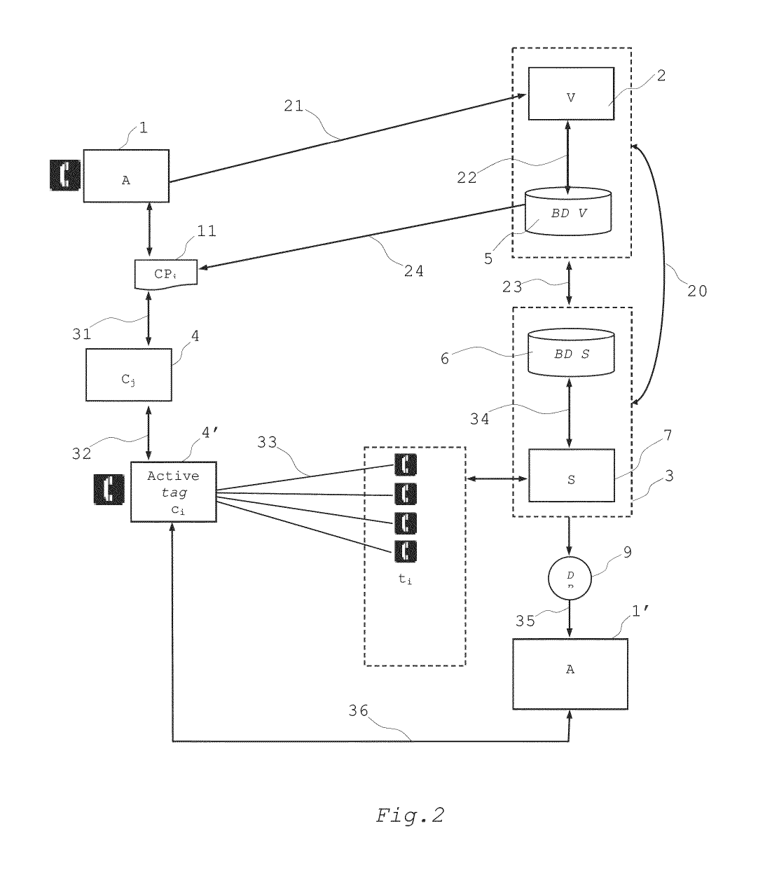

The method of the invention is characterized also, as seen in FIG. 2, by the fact that whenever an entity A of advertiser (1) orders an advertisement with a tag to one or more entities V for placement (2), said advertisement receives an active tag automatically generated by the server of the entity of placement (2), comprising at least one private telephone number tᵢ of the entity S that provides a service of responses monitoring (3) and a code cᵢ that identifies the promotional communication CPᵢ.

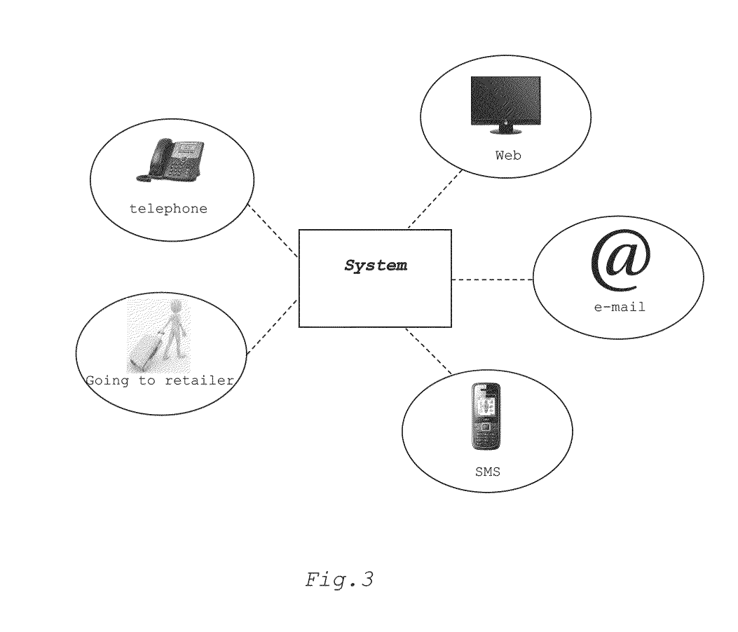

According to FIG. 3, the consumer response channels comprise telephony, SMS messages, web pages, e-mails and direct visits to stores L owned by retailers or by the advertiser (1). The measurement of these visits can be made through the electronic coupon.

According to FIG. 2, the method for monitoring responses to promotional communications is characterized by the fact that the set-up step and the tracking step comprise together the following steps:
One or more entities V for placement (2), previously sign a contract (20) with the entity that provides a service of responses monitoring (3), which allows it to get, periodically and automatically, from the advertisement database (5), information (23) about the advertisements that have active tags which were set forth in said contract (20);
At least one entity V for placement (2) publishes the promotional communication (24) CPᵢ in an offline or online media (11), with active tag (tᵢ, cᵢ), which contains a phone number tᵢ and a code cᵢ which identifies the communication CPᵢ;
A consumer Cⱼ reads the advertisement CPᵢ on media (11) and responds (31) via the telecommunication system T, using (32) the active tag and employing the phone number tᵢ and the code cᵢ;
The telephone tᵢ of the entity S providing services (3) is activated (33), and the information about the origin of the call, time and identification of CPᵢ is automatically transmitted to the server (7);
Said information is registered (34) in the database (6) of the entity that provides services (3), and the interfaces or displays (10) related to CP; are updated in real time, as shown in FIG. 1;
The call of the consumer (respondent) is automatically redirected (35) by the redirectioning device (9) to the advertiser entity (1);
The consumer Cⱼ is served (36) directly by an attendant (1′) of the advertiser entity (1);
The displays (10) are automatically updated with the information related to the responses of the consumer cⱼ, said information becoming available for consultation on the servers of the entity V for placement (2) and of the entity A of advertiser (1). Such updates include also information related to the media which originated the response, the items purchased by the consumer, the local, data and time of the purchase, as well as the credits that the manufacturer owes to the retailer in case of costly promotions, that is, promotions that generate a compensation owed to the retailer by the manufacturer. Such information is available on the interfaces (10) and it can be accessed by the entities V for placement (2), entities A of advertisers (1), retailers L (11), and manufacturers (not shown in the figures).

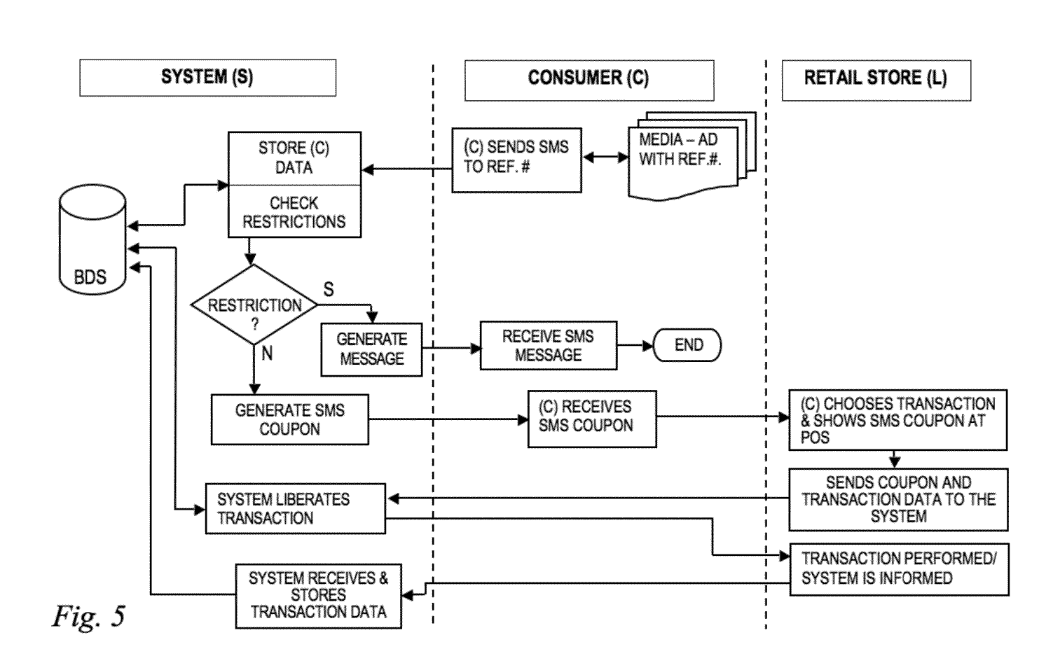

FIG. 5 illustrates the method corresponding to the embodiment shown in FIG. 1-c. In this method, the consumer's “call to action” is made by the mobile phone system. Initially, the consumer (respondent), after learning of the advertisement placed in offline media, sends a SMS to a number indicated in the advertisement, showing the respective reference number or tag. The service provider entity (5) receives and saves the data of this respondent, and checks whether there is any restriction (for example, if the consumer has previously responded to the advertisement), generating a SMS message that includes the electronic coupon, which is shown in the consumer's cellphone. The consumer goes to the business establishment and shows said coupon to an employee, to validate the transaction. This validation includes the access of the POS to the entity (S) via web interface, sending the data of the coupon and of the transaction, and receiving a positive or negative response. Finally, the transaction is completed and reported to entity (S), which stores the information.

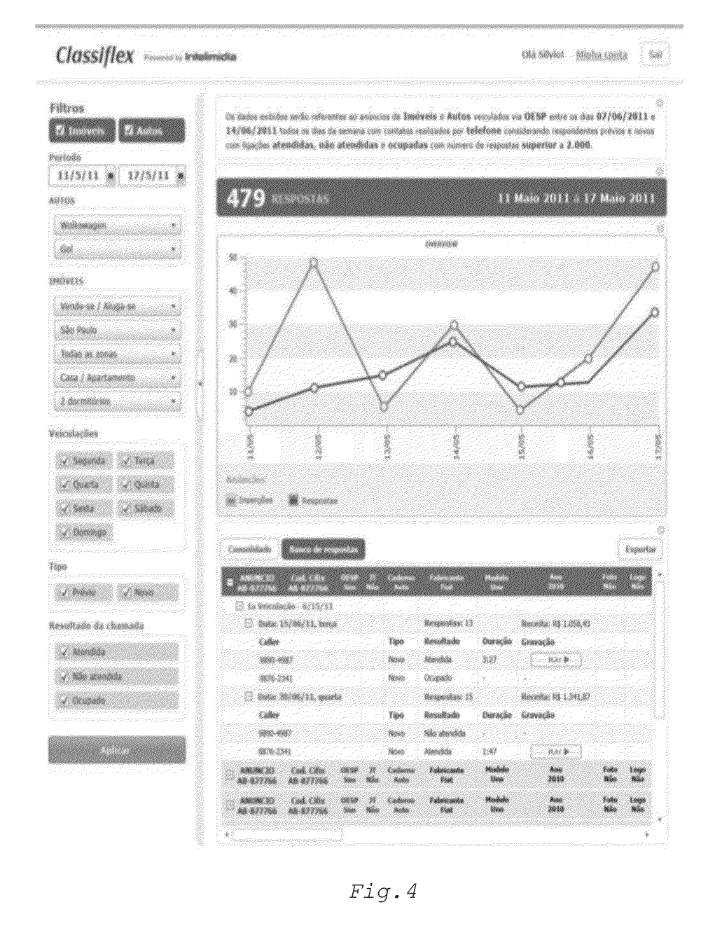

FIG. 4 illustrates a graphical interface that allows the user to check the relevant information of an advertisement. Thus, for example, there is a graph corresponding to the week of the day 11/05 to 17/05, showing the number of daily placements of the advertisement (broken dash line) and the number of responses (full line), enabling the evaluation of the relative effectiveness of the advertisement as a function of the placement day. On the left side of this interface are illustrated various filters which can be activated by the user, in order to cause the graph to show more detailed information, such as, for example, those related to certain publisher brand or particular types of real estate.

The detailed description of the above embodiments is merely exemplary and does not limit the scope of the invention. Several variations of the invention as set forth will be possible without departing from the scope thereof, which is defined by the claims that follow.

1. A system for a precise and complete assessment of the effectiveness of promotional communications, integrating, in a single platform, the measurement of the multiple means a consumer can engage to an ad published in an offline medium, wherein said system comprises and integrates one or more entities A of advertisers (1), one or more entities V for placement (2), having servers connected to an advertising database (5), an entity S providing a service of responses monitoring (3), having one or more servers (7) connected to an advertising database (6) with active tags, a plurality of entities C of consumers (4), a telecommunication system T (8), at least a device DR for redirectioning (9) of calls, retail stores entities L (11), means for generation of electronic coupons (12) through mobile phone SMS messages, and interfaces (10) for responses monitoring in real time.

2. A system according to claim 1, wherein said telecommunications system T (8) comprises landline and mobile telephony, SMS messages, Internet websites.

3. A system according to claim 1, wherein said electronic coupons (12) are integrated with the POSs (points of sale) in a single platform, providing the advertiser with information about the analytics related to said POSs.

4. A system according to claim 1, wherein said entity S providing a service of monitoring (3) comprises means for automatic generation of a tag associated to an advertisement, whenever this advertisement is ordered by an entity A of advertiser (1) to at least one entity V for placement (2), said tag comprising at least one private telephone number tᵢ of the entity S and a code cᵢ that identifies the promotional communication CPᵢ.

5. A method for integrated assessment of the effectiveness of promotional communications, comprising a campaign set-up, tracking and optimization steps.

6. A method according to claim 5, wherein said set-up and tracking steps comprise:
One or more entities V for placement (2) previously sign a contract (20) with the entity that provides a service of responses monitoring (3), which allows it to get, periodically and automatically, from the advertisement database (5), information (23) about the advertisements that have active tags which were set forth in said contract (20);
At least one entity V for placement (2) places the promotional communication (24) CPᵢ in an offline medium (11), with active tag (tᵢ, cᵢ), which contains a phone number tᵢ and a code cᵢ, which identifies the communication CPᵢ;
A consumer Cⱼ reads the advertisement CPᵢ on medium (11) and responds (31) via the telecommunication system T (8), using (32) the active tag and employing the phone number tᵢ and the code cᵢ, or an e-mail message;
The telephone tᵢ of the entity S that provides service (3) is activated (33), and the information about the origin of the call, number of calls, time and identification of the respondent, recording of the call and other analytics of the communication CPᵢ, which are registered (34) in the database (6) of the entity that provides service (3), is automatically transmitted to the server (7), and the interfaces (10) related to CPᵢ are updated in real time;
The call of the respondent consumer Cⱼ is automatically redirected (35) by the redirectioning device DR (9) to the entity A of advertiser (1);
The consumer Cⱼ is served (36) directly by an attendant (1′) of the entity A of advertiser (1);
The interfaces (10) are automatically updated with the information related to the responses of the consumer Cⱼ, said information becoming available for consultation on the servers of the entity V for placement (2), of the entity A of advertiser (1), and of the entities L of retail stores (11).

7. A method according to claim 6, wherein said set up and tracking steps comprise the use of electronic coupons, wherein:
Electronic coupons (12) of a certain promotional campaign (11) of an advertiser (1) are requested by the advertisements respondents and sent to cell phones of these requesters, utilizing tags (4′) provided by the entity S (3);
The consumers respond to the campaign by sending a SMS message to the entity (3), including in this message the corresponding tag;
The service entity generates a SMS message of response, which is specific to the respective consumer, which includes a specific identifier code;
The consumer goes to the retail establishment L where he/she performs a transaction;
The retail establishment L communicates the result of the transaction in real time to the entity S, which stores the respective data, while the interface (10) is automatically updated with the information associated with the responses of the consumer said information becoming available for consultation on the servers of the entity V for placement (2), of the entity A of advertiser (1), of the entities L of retail stores (11) and of the manufacturers, wherein this information comprises the items purchased by the respondent, place of purchase, date and time of the transaction and whether there is a credit owed by the manufacturer to the retailer.
